(19) United States
(12) Patent Application Publication
(10) Pub. No.: US 2014/0116341 A1
(43) Pub. Date: May 1, 2014

(54) METHOD FOR MANAGING DAIRY PRODUCTION

(71) Applicant: Farmeron, Inc., Wilmington, DE (US)

(72) Inventors: Matija Kopic, Osijek (HR); Ana Herman, Zagreb (HR)

(73) Assignee: Farmeron, Inc., Wilmington, DE (US)

(21) Appl. No.: 14/064,885

(22) Filed: Oct. 28, 2013

Related U.S. Application Data
(60) Provisional application No. 61/719,236, filed on Oct. 26, 2012.

(51) Int. Cl. A01J 99/00

(52) U.S. Cl. CPC A01J 99/00
USPC 119/14.02

(57) ABSTRACT

One variation of a method for managing dairy production includes: retrieving a set of electronic feed data for feed materials; receiving life events of a milking animal, including a gynecological status of the milking animal; collecting milking records corresponding to milking events of the milking animal; generating a milk production model for the milking animal based on the life events and milking records; in response to entry of a target milk production value for the milking animal, generating a feed schedule specifying a combination of feed materials based on the milk production model and the electronic feed data to achieve the target milk production value by the milking animal and estimating a milk production profit corresponding to achievement of the target milk production value; and, in response to entry of a target feed value, generating a feed schedule and estimating a milk production value for the milking animal.

### CROSS-REFERENCE TO RELATED APPLICATIONS

This application claims the benefit of U.S. Provisional Application No. 61/719,236, filed 26 Oct. 2012, which is incorporated herein in its entirety by this reference.

### TECHNICAL FIELD

This invention relates generally to the field of dairy farming, and more specifically to a new and useful method for managing milk production in the field of dairy farming.

### BACKGROUND

Americans consume roughly 430,000 gallons of milk each day. To keep track of this level of milk production, dairy farmers often rely on manual-entry spreadsheets for recordkeeping of their farms. However, these spreadsheets fail to provide adequate milk production forecasts due to the limited number of inputs they track. Furthermore, animal feed can account for upward of 40 to 70 percent of milk production costs, and yet these manual spreadsheets often fail to provide insight into the effects of feed on dairy production. Therefore, there is a need in the field of dairy farming to create a new and useful method for managing dairy production. This invention provides such a new and useful method.

### BRIEF DESCRIPTION OF THE FIGURES

FIG. 1 is a flowchart representation of a method of one embodiment of the invention;

FIG. 2 is a flowchart representation of one variation of the method;

FIG. 3 is a flowchart representation of one variation of the method;

FIG. 4 is a graphical representation in accordance with the method;

FIG. 5 is a graphical representation in accordance with the method;

FIG. 6 is a graphical representation in accordance with the method; and

FIG. 7 is a flowchart representation of one variation of the method.

### DESCRIPTION OF THE PREFERRED EMBODIMENTS

The following description of the embodiments of the invention is not intended to limit the invention to these embodiments, but rather to enable any person skilled in the art to make and use this invention.

### 1. The Method and Applications

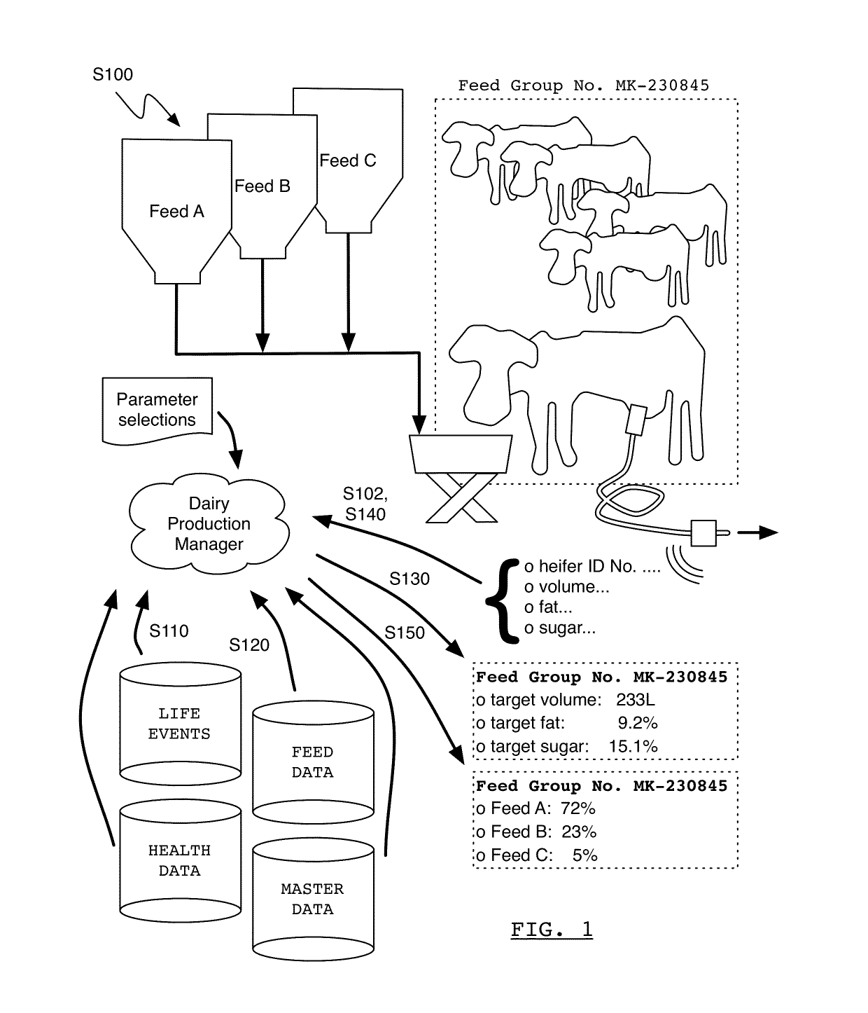

As shown in FIG. 1, a method S100 for managing dairy production includes: retrieving a set of electronic feed data comprising nutrition data for feed materials in a set of available feed materials in Block S120; receiving a set of life events of a milking animal in Block S110, the set of life events comprising a gynecological status of the milking animal; collecting a set of milking records in Block S140, each milking record in the set of milking records corresponding to a milking event of the milking animal; generating a milk production model for the milking animal based on the set of life events and the set of milking records in Block S130; in response to entry of a target milk production value for the milking animal, generating a feed schedule for the milking animal based on the milk production model and the set of electronic feed data in Block S150, the feed schedule specifying a combination of feed materials in the set of available feed materials to achieve the target milk production value by the milking animal, and estimating a milk production profit corresponding to achievement of the target milk production value by the milking animal in Block S130; and, in response to entry of a target feed value, generating a feed schedule for the milking animal based on the target feed value in Block S150, the feed schedule specifying feed timing and a feed material in the set of available feed materials, and estimating a milk production value for the milking animal based on the feed schedule and the milk production model for the milking animal in Block S130.

One variation of the method S100 includes: receiving a production status of a group of milking animals in Block S110; retrieving a set of feed data including nutritional data and cost data for feed materials in a set of available feed materials in Block S120; collecting a milking record including a milk production output value of the group of milking animals in Block S140; identifying a correlation between the milk production output value and a feed schedule of the group of milking animals in Block S130; setting a target milk production value for the group of milking animals based on a projected milk price, the production status, the correlation between the milk production output value and the feed schedule in Block S130; and updating the feed schedule for the group based on the feed data and the correlation between the milk production output value and the feed schedule to achieve the target milk production value within the group of milking animals in Block S150.

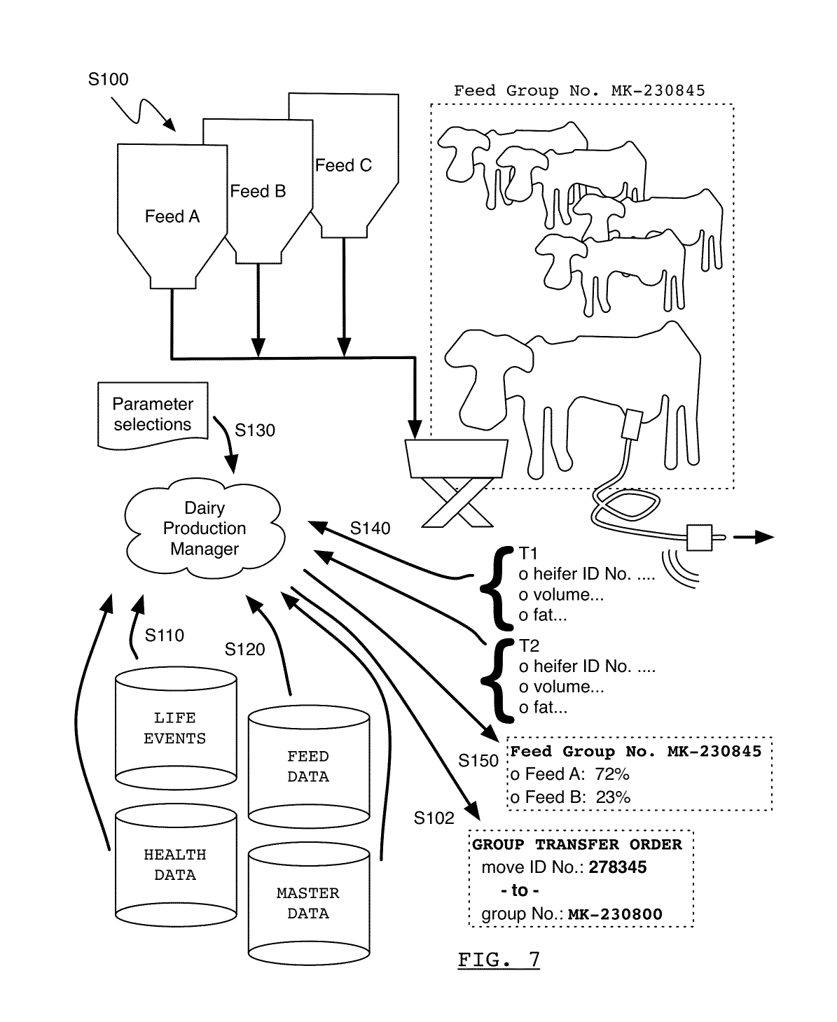

As shown in FIG. 7, another variation of the method S100 includes: retrieving a set of electronic feed data comprising nutrition data for feed materials in a set of available feed materials in Block S120; receiving a set of life events of a first group of milking animals in Block S110, the set of life events comprising a gynecological status of a milking animal within the first group of milking animals; collecting a set of milking records in Block S140, each milking record in the set of milking records corresponding to a milking event of milking animal within the first group of milking animals; in response to entry of a target milk production value for the first group of milking animals, generating a feed schedule for the first group of milking animals based on the set of life events in Block S150, the set of milking records, and the set of electronic feed data, the feed schedule specifying a feed timing and a combination of feed materials in the set of available feed materials to achieve the target milk production value by milking animals in the first group of milking animals; in response to detecting deviation from the target milk production value by a particular milking animal in the first group of milking animals, selecting a second group of milking animals with characteristics compatible with the particular milking animal based on the deviation from the target milk production value and the feed schedule; and prompting placement of the particular milking animal into the second group of milking animals in Block S102.

Generally, the method S100 functions to accommodate variables that affect current and future milk production within a group of milking animals (i.e., animals that produce milk fit for human consumption) to generate feed schedules tailored for milk production targets for the group. By tracking and aggregating effects of milk production-related variables for the group over time, the method S100 can generate a granular multi-variable model of milk production within the group of milking animals and, from this model, provide comprehensive insights into interrelated processes of dairy farming. Once the effects of these processes on dairy production are extracted, the method S100 can enable identification of root causes of performance deviation and can leverage these effects to tailor milk production factors to animal needs, farm/farmer needs or expectations, and general milk demand. The method S100 can also synthesize, report, and analyze new production results to further inform the milk production model with quantitative, qualitative, and financial data. For example, the method S100 can input milk pricing and feed costs into the model defining a relationship between feed nutrition schedules and milk quantity and quality output for the milking animal group to determine an optimum milk production to maximize profits from milk production within the group and to output a feed schedule to achieve (roughly, approximately) the optimum milk production within the group. The method S100 can further incorporate weather data, veterinary or animal health data, master records, past production data, and/or past or current data of other farms, etc. to bolster the milk production model.

The method S100 can therefore aggregate animal group and dairy production-related data (from various sources) to capture a real-time “pulse of dairy production.” The method S100 can therefore be useful to a user (e.g., a farmer, farm manager, or other person authorized by the farm) of a dairy farm with a herd of milking animals including one or more groups of milking animals, such as in setting and achieving internal production targets for the one or more groups of milking animals. The method S100 can also be implemented across multiple dairy farms, such as on a local, state, regional, national, or international level to aggregate dairy production data automatically and in real-time. For example, a dairy farming conglomerate, an agricultural regulatory body (e.g., the U.S. Department of Agriculture), a local, state, or national governing body, quality control agencies, environmental agencies, (agricultural) economists, veterinarians, farming consultants, animal feed or drug manufacturers, animal feed shipping companies, upstream suppliers, downstream buyers, livestock auction houses, or any other entity involved in or related to dairy production can thus access such aggregated data to identify current milk supply, predict future milk supply, predict overages or underages in milk production, identify milk quality or characteristics by farm, region, etc., set milk prices, monitor dairy production with a set or subset of herds or animal groups, etc. For example, a regulatory body can use dairy production data collected and manipulated within the method S100 to set a current or future market price for milk and corn, adjust dairy subsidies, or structure milk release into the market based on a current snapshot and/or forecast of total local, regional, national, and/or international dairy production. In another example, an economist can manipulate national milk production forecasts generated by the method S100 to predict future food costs that fluctuate with milk prices. In yet another example, a veterinarian can access health, fertility, and milk production data from one or more local farms to diagnose disease within an animal group, to prescribe certain treatments or medications to all or a subset of animals within the herd, and/or to analyze frequency of diagnoses within or across herds. In a further example, animal breeders can identify particular high-yield milking animals and set auction prices for these animals based on milk production data and trends identified within the method S100. However, data collected, analyzed, and/or synthesized by the method S100 can be accessed and implemented in any other way by any other suitable entity.

The method S100 can generate target milk production values and feed schedules for a (homogenous) group of milking animals within a larger animal herd, such as based on a short-term or long-term cost, revenue, profit, capital utilization, herd size, target milk quantity or quality, milking animal lifespan, milking animal time to first calving, feed availability, weather forecast, feed crop success, or any other parameter set, entered, or adjusted by a user (farmer, farm manager, or other entity associated with a milking animal) for a group of milking animals, a milking animal herd, a dairy farm, or a dairy-related enterprise, association, or cooperation. For example, a dairy farmer can set a maximum cost for herd feed for the ensuing week (e.g., based on a maximum available current capital available for feed purchase), and the method S100 can generate a target milk production quantity of a target milk quality across the herd during the ensuing week to maximum profit from the herd in light of milk prices for milks of various qualities, available capital (e.g., farmhands, machinery, etc.), weather forecast for the ensuing week, and stored and available feed. In another example, the dairy farmer can set a target weekly milk volume production for his herd (or animal group or particular animal, etc.) in one-year's time, and the method S100 can generate feed schedules, corresponding target milk production figures for subsequent weeks, insemination schedules, feed purchase orders, machinery orders, labor pool orders, etc. to achieve the long-term milk volume production target for herd. To output any of the foregoing schedules, orders, etc., the method S100 can aggregate machinery data (e.g., machine maintenance, food delivery, milking machine, crop harvest, building, and infrastructure data), labor data (e.g., feeder, veterinarian, milker, driver, administrator, and salesman data), partner data (e.g., supplier, buyer, institution, advisor, insurance, and veterinarian data), animal (e.g., age, weight, fertility, origin, purchase price, etc. data), location data (e.g., barn housing data), material data (e.g., feed, drug, maintenance, lead time, and minimum order quantity data), etc. of the herd, farm, association, etc. over time to generate a corresponding diary production model defining relationships between any of the foregoing parameters, milk production, production costs, production revenues, and herd values. The method S100 can then generate new schedules and orders and/or modify existing schedules and orders in response to a short-term, mid-term, and/or long-term parameter change entered by a farmer or associate.

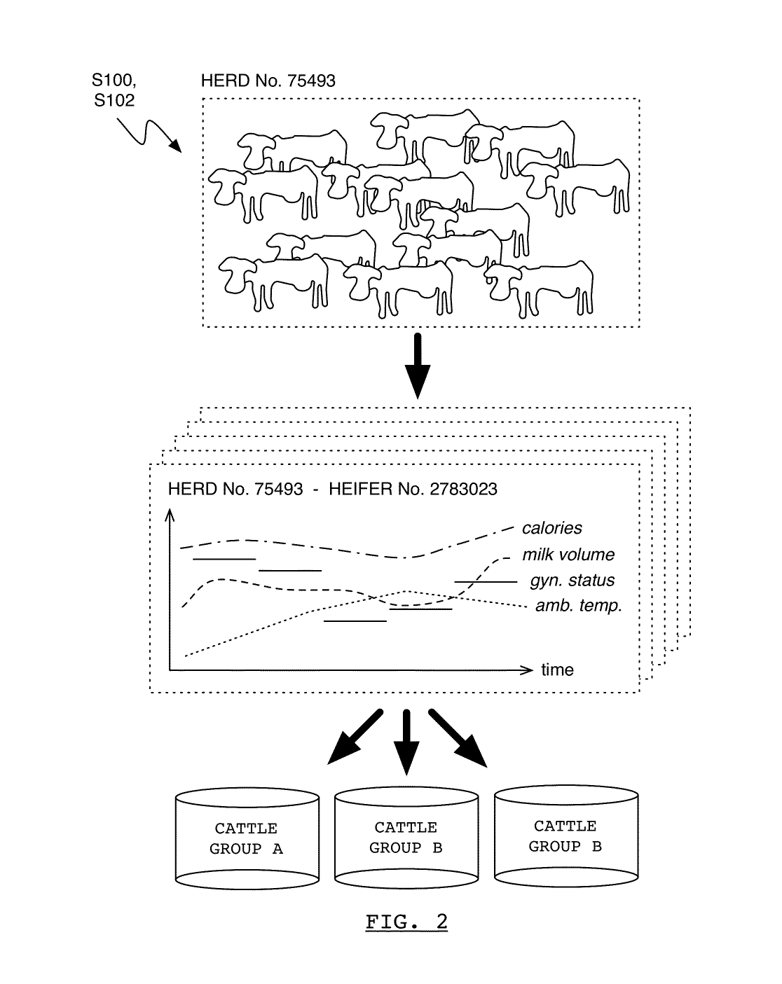

The animal group can define a feeding group including a set of animals of mutually-compatible characteristics. Animals within the herd can be grouped according to any one or more of life stage (e.g., milk heifer, dry cow, dry heifer, calf, etc.), sex, production stage, nutritional demand, lactation stage, reproductive cycle, size, weight, age, type, milk yield, gynecological (i.e., fertility) stage (e.g., birth, heat, inseminated, aborted, fresh, open, not for insemination), location, country of birth, entry type, partner, genetic potential, days in milk, days carrying calf, milk quantity, milk quality, somatic cells, etc., as shown in FIG. 2. For example, on a dairy production farm with 10,000 individual head of cattle, the group of milking animals can define a feeding group including twenty individual animals of similar age, lactation stage, and weight. Each animal in the group of milking animals can be tracked or managed manually, such as with ear tags, nose tags, or brands, or electronically, such as with a worn electronic tracking device or an under-skin RFID chip that broadcasts a (unique) head identification number and/or group identification number of the milk cow. Each individual animal within the group can be assigned a unique identifier, or the group as a whole can be assigned a single identifier. Animal-related data collected over time in various Blocks of the method S100 can be tagged with identifiers of corresponding animals and inserted into the milk production model accordingly to group-specific target production values, feed schedules, management directives, etc. The method S100 can additionally or alternatively generate target milk production values, feed schedules, future incomes from milk sold, animals sold, feed and water costs, health, fertility, machine-pool and labor-pool costs, etc. for a specific animal within the animal group, for multiple animal groups, for the animal group, and/or for a whole animal herd.

Performance (e.g., milk output) within animal groups can be represented in tabular or graphic form, such as for comparing performance of the animal group over a time interval, for comparing performance of different animal groups over time, for comparing different parameters within the same group (e.g., heat stress index vs. number of abortions in a period of time for animals in a second lactation), etc.

The method S100 can be implemented by a computer system, such as a herd management service that collects life events, feed, and milk production data of milking animals, specifies milk production targets, and generates feed schedules. The computer system can be a cloud-based computer (e.g., Amazon EC2), a mainframe computer system, a grid-computer system, or any other suitable computer system. The computer system can support a messaging platform for communicating messages with a farm, a farmer, a farmhand, an automated milking system or data server, a feed production or storage facility, a regulatory body, a veterinarian, or any other entity involved in or related to milk production. For example, the computer system can support, distribute, and collect feed orders, medication prescriptions, milking data, feed storage records or updates, weather (e.g., ambient) data, crop data, animal health data, or any other milk production-related data from various entities on and off a dairy farm. The method S100 can communicate these data over a computer network, such as over the Internet, wherein one or more processors within the computer network implement one or more Blocks of the method S100.

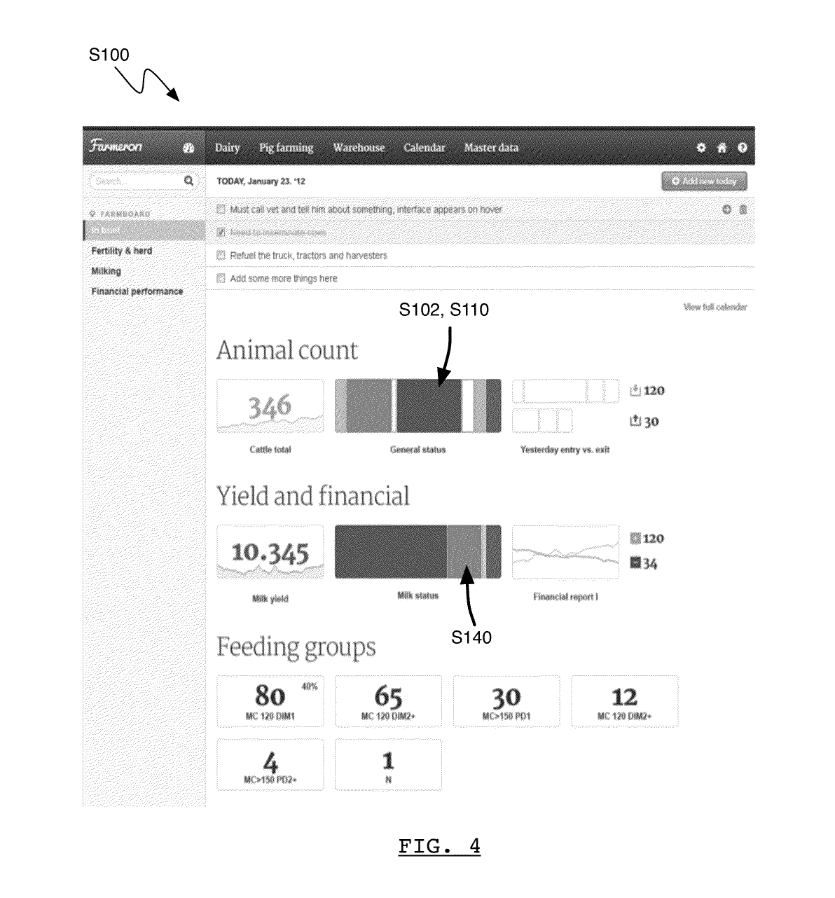

The computer system can also incorporate a farmer-side interface or “dashboard”, as shown in FIGS. 4, 5, and 6, to enable master access to a dairy production account containing any of the foregoing and forthcoming data. The computer system can also incorporate veterinarian, consultant, farmhand, and/or feed management interfaces, etc. through which one or more corresponding users or entities can access, augment (i.e., add), and/or manipulate milk production data. For example, a user can interface with the dashboard to authorize and set data review and entry permissions for various users involved in milk production and/or herd maintenance. Generally, the dashboard (and other interfaces) can be accessible through a web browser or through a native application executing on an electronic device, such as a laptop computer, a desktop computer, a tablet, a smartphone, a personal data assistant (PDA), etc.

As described below, the user (e.g., a farmer, farm manager, veterinarian, etc.) can link to and/or upload various health, life event, production, animal entries and exits, and other data to the dairy production account over time during milk production and herd management. The farmer or other user can also initiate the method S100 through an on-boarding process, such as by entering or linking base milking animal and farming information. However, the method S100 can be implemented by any other one or more computers, networks, servers, processors, etc. to manipulate data supplied manually by one or more users or automatically by one or more connected machines.

The method S100 can be applied to dairy production by any one or more types of milking animals, such as milk collection from cows, sheep, goats, donkeys, mares, rabbits, etc. The method S100 and variations thereof can be similarly applicable to other forms of animal husbandry, such as pig farming, poultry farming, fish farming, egg production, etc. to monitor and control feed production to achieve target production values.

### 2. Life Events

Block S110 of the method S100 recites receiving a set of life events of an animal group, the set of life events including a gynecological status. (Block S110 can similarly recite receiving a production status of a group of milking animals). Generally, Block S110 functions to collect various data pertaining to a group of milking animals, such as feeding, milking, health, fertility, and milk production events, any of which may trigger changes in lactation, gynecological and health status, etc. Block S110 can then pass any of these data to Block S130 as milk production-related variables to generate a multi-variable model of milk production within the group. For example, for one or more individual animal within the animal group, Block S110 can collect information relating to any one or more of birth date, auction or purchase date, feed history (e.g., schedule, content, quantity), nutritional demand, reproductive history (e.g., inseminated, expected pregnant, diagnosed pregnant, birth pending, recent birth), immunological history, exposure to weather (e.g., drought, rain, indoor and outdoor temperature, indoor and outdoor humidity, indoor and outdoor oxygen level, light, heat stress index, moon phase), weight, age, number of days in milk, days carrying calf, growth rate, maturity rate, life stage (e.g., milk heifer, dry cow, dry heifer, calf, etc.), lactation stage, size, weight, type, housing need, or any other relevant life data for one or more individual animal within the group. Block S110 can therefore collect, store, and deliver relevant animal information to assemble a foundation for dairy herd management through a milk production model for one or a group of milking animals.

In one implementation, Block S110 retrieves previous feed schedules and corresponding feed periods (i.e., times) assigned to the animal group and assembles a timeline of nutrition supplied to the animal group based on feed nutrition data collected in Block S120 (described below). For example, Block S110 can generate a chart of moisture, dry matter, different kind of energy (i.e., UE, ME, NEL, NEG), ashes, different kind carbohydrates, (i.e., starch, sugar, soluble fibers), proteins (i.e., CP, RDP, RUP, RUP digestible, usable protein), raw fat, ADF, NDF, lignin, micro elements, etc.) assigned or distributed to or consumed by one animal or the animal group on a certain day or over a certain time. In this implementation, Block S110 can additionally or alternatively interface with a feed storage facility database, a feed manager dashboard, or other electronic server or interface to collect processed feed orders for (i.e., feed elements fed to) the animal group. Block S110 can also receive manual feed inputs, such as from the farmer or from a farm manager, over time and assemble these data into the feed timeline.

Block S110 can also retrieve a gynecological history of animals within the group, including fertility periods, insemination periods, abortion and calving events, insemination successes, pregnancy periods, birth periods, birth successes, reproduction health check results, diagnoses and treatments relating to reproduction problems, conception, pregnancy and abortion rates, days carrying calf, etc. Block S110 can then assemble these data into a timeline of gynecological events within the animal group. In this implementation, Block S110 can collect gynecological data for the group through manual inputs into the dashboard by the farmer, by interfacing with a health record database maintained with a veterinarian affiliated with the herd and/or with the animal group, or in any other suitable way.

Block S110 can similarly collect an environmental history of the animal group. For example, Block S110 can collect local weather data from a weather database over time and maintain a record of housing of the animal group (e.g., in a field, in an open paddock, in a closed and heated barn or stall, etc.) over time. In this example, Block S110 can combine the local weather data and the housing records to generate an exposure timeline for the group, including temperatures, rainfall, humidity, and other environmental and ambient conditions experiences by the animal group over time.

In the foregoing implementation, Block S110 can collect micro-location weather-related data based on a location of the dairy farm (e.g., ranch), the location of local feed crops, and/or the location of the group of milking animals or herd. For example, Block S110 can collect a location through a computer or a mobile computing device used by the farmer or by a farmhand to access outputs of the method S100. Block S110 can alternatively receive a location broadcast by a location-tracking device worn by one or more head within the animal group. However, Block S110 can collect location data in any other suitable way. Based on any of the foregoing location data, Block S110 can pull past, current, and/or forecast weather conditions for the received location, such as from a weather server, a weather services, or directly from a weather satellite. Because feed crop production, animal nutrition and water demands, milk output, and other aspects of dairy production may be affected by weather, Block S110 can pass location-specific weather data to Block S130 for insertion into the milk production model described below. For example, Block S130 can correlate weather history with historic milk production figures and factors to isolate weather- and/or environment-related trends in milk production within the animal group, such as described below.

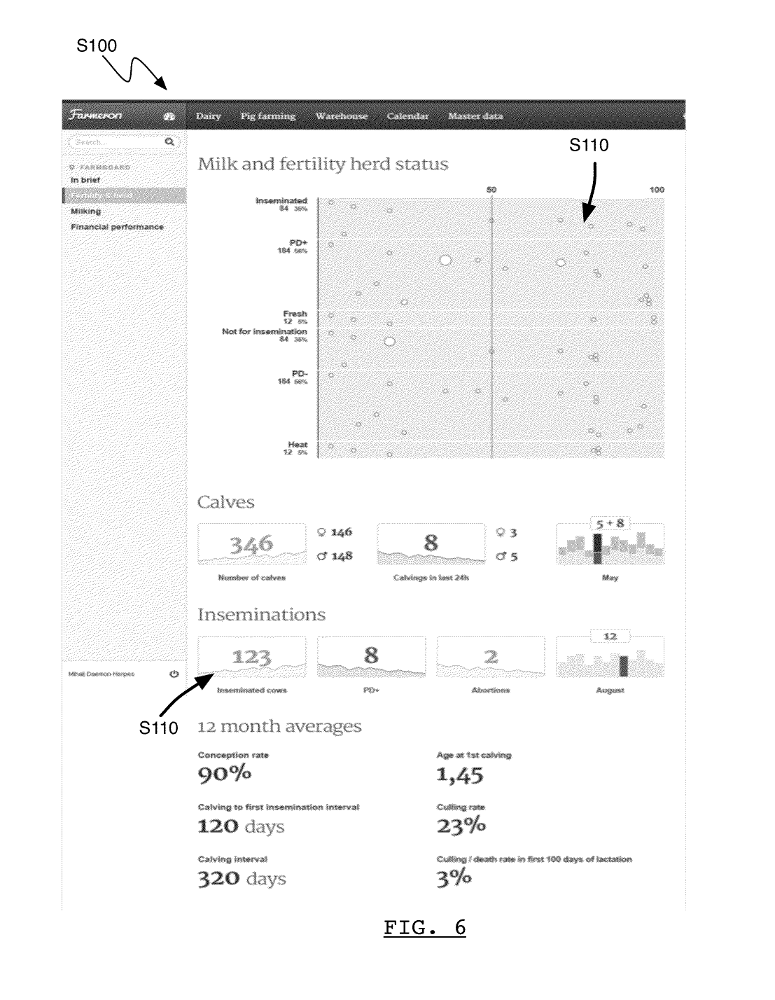

Block S110 can further collect herd and/or group entries and exits for specific animals within the group, such as when a particular individual animal was purchased, moved into the group, moved into another group, sold, expired, etc., and Block S110 can assemble these data into a timeline(s) of events or triggers for production status changes, health changes, etc. However, Block S110 can collect any other suitable data from any other manual or electronic source and assemble this data into any one or more timelines pertaining to the animal group and/or a subset of animals within the group. As any of the foregoing data and/or is collected over time, Block S110 can display these data and/or timelines within the farmer's interface or dashboard, as shown in FIG. 6. Block S110 can similarly enable access to all or a subset of these data and/or timelines to select other users, such as a veterinarian to enable remote diagnosis or health monitoring for the group of milking animals.

In one implementation, Block S110 can apply rules corresponding to various farming roles to define data input and access authorization for various users. In particular, Block S110 can define a scope and a depth of activities authorized for a user of a certain type (i.e., role) within the system, such as a user's authority to make record movements, to enter, change, or delete master record, to input or update status or event documents, to generate and analyze reports, etc. In one example, Block S110 can authorize data input and access at a herd level, at a farm level, at an enterprise level (e.g., for a group of affiliated farms), or at a cooperative or association level, etc.

### 3. Health Data

Block S110 can further receiving health data pertaining to the animal group, such as disease, insemination, fertility, or pregnancy diagnoses, immunization data, medication or prescription data, birthing data, weight or size status, health check, health treatment, vaccination, hoof trimming or quarantine events, and/or any other health-related data for animals within the group. At least some of these data can be entered automatically, such as by a feed facility that mixes antibiotics with feed. Additionally or alternatively, these data can be entered manually, such as by a farmhand who artificially inseminates a milk cow or by a veterinarian who prepares diagnoses for the animal group. Block S110 can therefore collect animal health data from a variety of sources.

Block S110 can also collect and implement data review and edit permissions for these various sources, such as permissions set or selected by the farmer or farm manager. For example, Block S110 can prescribe review and edit permissions for a veterinarian associated with the feeding group, and these permissions can enable the veterinarian to perform remote diagnoses for the group and to enter diagnosis into the corresponding dairy production account. In this example, once entered health data is entered by the veterinarian, Block S110 can disseminate the diagnosis to a farmer, farmhand, feed facility, or other related entity to support management of the animal group, and Block S110 can further add data supplied by the veterinarian the health history of one or more head within the feeding group with the diagnosis. Block S110 can also set subsequent deadlines, triggers, or other notifications for responding to the diagnosis and distribute these notifications to relevant parties, such as to the farmer and/or to the veterinarian. (The method S100 can similarly enable remote consultations from dairy production consultants by enabling remote access to animal and farm data.) However, Block S110 can function in any other way to retrieve and collect health-related data of one or more animals within the feeding group.

As health data of the animal group is collected over time, Block S110 can assemble these health data into one or more time-dependent health charts or graphs. In one example, Block S110 generates a timeline of disease diagnoses, medications, and disease progress within the animal group. In one example, Block S110 generates a timeline of animal age, weight, and reproductive (i.e., gynecological) status. However, Block S110 can generate any other time-dependent representations of animal health data in any other way as health-related data is received over time from one or more manual or automated sources.

### 4. Master Data

In one implementation, Block S110 accesses master record data including technical, financial, performance, and other quality- and quantity-related data pertaining to resources engaged by the farm to maintain the animal group. Block S110 can collect master record data that is structured in homogenous groups of respective resources, such as animal master records, animal location master records, material master records, partner master records, machine pool master record, labor master records, and internal and external static resources, cost, and action data. For example, Block S110 can collect data pertaining to production materials, milking animal identifiers and animal group assignments, barns and facilities, machinery and capital, labor and labor pools, facility schedules (e.g., personnel schedules, pickup and delivery schedules), and local and corporate partners. Block S110 can also access current and predicted market demand, market pricing, milk supply, milk demand (e.g., quantity, quality), and milk regulations. Block S110 can collect milk production waste data, such as the quantity of waste per head or feeding group, quality of waste (e.g., if suitable for fertilizer), waste management systems, and waste management cost. As described above, Block S110 can collect master record data from manual entries (e.g., by a farmer), from external servers or networks (e.g., a server maintained by an agricultural regulatory body), and/or from automatic data collection systems (e.g., automated waste removal systems).

Block S110 can then pass any of the foregoing master record data to Block S130 for insertion into the milk production model. For example, Block S130 can apply master record data to the milk production to inform production costs, including waste management, capital, and personal costs, for milk output within the animal group. Block S130 can thus implement master record data to generate directives for dairy production planning, capacity utilization, waste calculation, investment demands, and cash flow, as described below. However, Block S110 can collect any other type of master record data in any other way, and Block S130 can implement these data to synthesize any other relevant output, as described below.

Block S110 can also recite receiving a set of life events of a milking animal, the set of life events comprising a gynecological status of the milking animal. Block S110 can therefore implement any of the foregoing methods or techniques to assemble data specific to a single milking animal.

### 5. Animal Group

As shown in FIG. 2, one variation of the method S100 includes Block S102, which recites collecting a set of animal identifiers and distributing the set of animal identifiers into discrete groups of milking animals based. Generally, Block S102 can interface with Block S110 to collect various data of animals with a herd, such as housing needs, gynecological statuses, and health statuses for animals within the herd, and Block S102 can then identify similarities such data between various animals and assemble discrete groups of milking animals (including the foregoing animal group) according to these identified similarities. Block S102 can therefore analyze existing animal data to automatically group animals within the herd based on various similarities relating to milk production.

Block S102 can output a list of animal identifiers for each animal group, each identifier corresponding to a particular individual animal within the herd. The farmer, farm manager, etc. can thus group the herd physically based on animal group lists output in Block S102. For example, the animal group lists output in Block S102 can be implemented by grazing, feeding, milking, and inseminating all milking animals within a group of milking animals together.

In one implementation, Block S102 receives entry of an additional animal identifier into an existing list of animal identifiers for an animal herd. In this implementation, Block S102 can then interface with various Blocks of the method S100 to receive life event, health, nutrition, and/or other data pertaining to an additional individual animal corresponding to the additional animal identifier. Block S102 can implement the foregoing data to identify similarities between the additional individual animal and a particular animal group within the herd and then insert the additional animal identifier into the particular animal group accordingly. Block S102 can thus automatically select an animal group for a new individual animal when the new individual animal enters the herd (e.g., after purchase from auction).

In another implementation, Block S102 interfaces with various Blocks of the method S100 to receive a health status, milk production, housing need, or other update for a particular individual animal within an animal group, and Block S102 can implement this data for the particular individual animal to select an alternative animal group for the particular individual animal. Block S102 can similarly remove a particular individual animal when the particular individual animal is sold, expires, or otherwise transitions out of a milk producing subset of the herd.

In one example implementation, the method S100 can generate a feed schedule for a group of milking animals to achieve a target milk production value (i.e., milk output quantity and/or quality), such as based on life events, milking records, and other animal group data collected in Block S110 and electronic feed data (as described below). However, Block S140 can collect subsequent milk records for the group of animals (as described below), and Block S102 can detect deviation from the target milk production value by a particular milking animal in the group of milking animals. Block S102 can respond to this detected deviation by identifying a more suitable animal group for the particular milking animal, such as by selecting an alternative group with characteristics more compatible with the particular milking animal. For example, Block S102 can identify milk production volume output by the particular milking animal that falls short of a target milk production quantity (e.g., volume, mass, weight) by a preset quantity threshold (e.g., more than 8%) over a set of milking periods (e.g., three consecutive days) and selecting the alternative group of milking animals that produces similar milk quantities for similar feed schedules. Alternatively, in this example, Block S102 can specify the particular milking animal for culling (i.e., removal from the herd) based on the deviation from the target milk production by the herd. In this example, Block S102 can also account for the age of the particular milking animal, the genetic potential of the particular milking animal to continue profitable milk production, etc. to determine if the particular milking animal should be culled or moved to an alternative group characterized by lower milk production than the particular milking animal's current group. Block S102 can then prompt placement of the particular milking animal into the alternatively group of milking animals, such as by issuing a notification within a farmer's dashboard. Alternatively, Block S102 can generate a notification (or work order) to move or cull the particular milking animal based on a unique animal identifier associated with the particular milking animal (and then transmit the work order to a farmhand for implementation). Block S102 can implement similar functionality to move a particular milking animal to another group characterized by higher milk production, to a group awaiting insemination, to a group pending or recently completing a birth, etc. based on the milk production figures, age, weight, and/or other data amassed in Blocks S110, S140, etc.

However, Block S102 can function in any other way to assign one or more animals to a group of milking animals within an animal herd based on data collected in any one or more Blocks of the method S100.

### 6. Animal Feed

Block S120 of the method S100 recites retrieving a set of electronic feed data including nutritional data for feed materials in a set of available feed materials. (Block S120 similarly recites retrieving a set of feed data including nutritional data and cost data for feed materials in a set of available feed materials.) Generally, Block S120 functions to collect data pertaining to available animal feed, such as quantity of stored feed, age or anticipated life of stored feed, location of stored feed (e.g., relative the feeding group), nutritional content of available feed, and/or feed cost.

These feed data can be entered manually, such as by a farmer, a farmhand, a feed production facility worker, a feed testing facility worker, or a feed crop (e.g., corn) farmer. For example, Block S120 can receive feed data for a particular available feed material entered manually into a dashboard or interface logged in to the dairy production account and then communicate these feed data over a computer network for storage in a remote database or server for subsequent implementation in Block S130 and/or Block S150. Alternatively, Block S120 can receive a feed material selection from a farmer, feed manager, etc., and Block S120 can automatically retrieve at least some of these data from one or more electronic sources. For example, Block S120 can mine nutritional information from an online resource supported by a feed production facility associated with a particular feed material, from a website supported by a distribution facility supplying a particular feed material, or a government regulatory authority. Yet alternatively, Block S120 can retrieve data collected directly by Internet-connected feed sensors in contact with stored feed, such as arranged within feed storage silos containing feed. However, Block S120 can function in any other way to retrieve any other feed-related information entered manually or collected automatically from any other source.

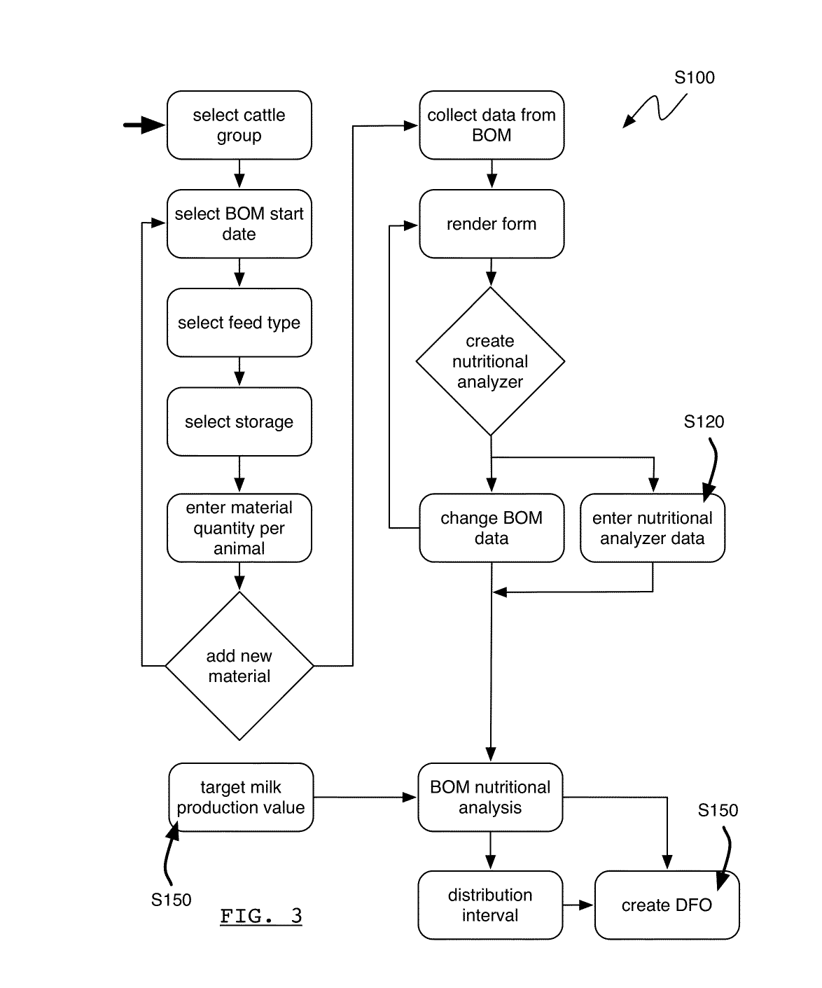

From these feed data, Block S120 can generate a feed nutrition model of available feed(s), as shown in FIG. 3. For example, Block S120 can implement a nutritional analyzer to output a feed nutrition model defining one or more of dry matter, energy, ash, starch, sugar, soluble fiber, beta glucan, crude protein, rumen digestible protein, rumen indigestible protein, usable protein, crude fat, ADF, NDF, lignin, and/or micro element content for each feed used by the dairy farm.

For a dairy farm using various types of feed or feed blends (e.g., a winter feed menu and a summer feed menu), Block S120 can model nutritional content of each feed supported by the single dairy farm. As described below, Block S130 can correlate milk production within the animal group with various factors, including nutritional content of feed supplied to the animal group and generate a milk production target for the animal group accordingly. Block S150 can similarly select a particular feed or a particular combination of feeds to meet a target feed nutrition to achieve the target milk production for the animal group.

As shown in FIG. 3, Block S120 can generate a bill of materials (“BOM”) for a particular feed. A BOM can include a nutritional model for a corresponding feed material and a quantity, quality, source location, storage location, hydration level, and/or other relevant data for the feed material on hand and/or available through a supplier.

As described above, Block S120 can collect cost data for various available feed materials. For example, Block S120 can retrieve a current feed price for a particular type of feed and pass this value to Block S130 and/or Block S150 to set the target milk production value and to generate the feed schedule, respectively. Block S120 can also compare the current feed price to previous prices for the feed and extrapolate trends in feed price to estimate a future price for the particular type of feed. Block S120 can then pass this estimated future feed price to Block S130 and/or Block S150 to set a future target milk production value and to generate a future feed schedule, respectively. Block S120 can similarly retrieve feed cost projections, such as from an economic survey or agricultural institution, and pass these data to Block S130 and/or Block S150.

However, Block S120 can generate a feed nutrition model of one or more available feeds in any other way and including any other data or metric.

### 7. Milking Files

Block S140 of the method S100 recites collecting a set of milking records from an automated milking system, each milking record in the set of milking records corresponding to a milking event for an individual animal within the animal group. (Block S140 can similarly recite collecting a milking record including a milk production output value of the animal group.) Generally, Block S140 functions to collect past and/or current milk output data for the animal group. Block S130 can implement these milking data to generate the milk production model that defines a relationship between milk output and one or more variables, such as nutrition and gynecological status, for the group.

In one implementation, Block S140 collects important dairy production data by interfacing with an automated milking system, such as shown in FIG. 1. In this implementation, Block S140 can collect milk production metrics automatically by downloading quantity (e.g., volume, weight, mass), quality (e.g., specific gravity, fat content, protein content, sugar content, lactose, urea, conductivity, milk activity, somatic cell count (SCC), acidity, color, cleanliness), milking animal identification number, animal group identifier, farm identifier, milking time, and/or milk volume flow rate, etc. directly from an automated milking machine. These data can be milking animal-, animal group-, herd-, or farm-specific. Block S140 can alternatively collect any of these data from a milking database or server connected to one or more automatic milking machines. Block S140 can alternatively collect this information from one or more sensors in contact with milk or milk containers holding milk produced by the animal group, such as by downloading milk-related data directly from a sensor or accessing sensor data stored in an electronic milking database. Block S140 can therefore interface with a remote server that collects and stores milking data from local automated milking machines, or Block S140 can interface directly with local milking machines to collect milking data directly.

In another implementation, Block S140 receives milking data entered manually into the dairy farm account and/or milking files uploaded manually to the dairy farm account, such as by the farmer, a farmhand, or a farm manager.

Block S140 can collect milking data on a daily, weekly, or other timed schedule, or in real-time during each scheduled milking event for the animal group. Block S140 can further assemble these milking data for various milking events into a timeline of milk production for the animal group. For example, for a particular milking event defining a milking period for animals within the animal group, Block S140 can receive, for each individual animal within the animal group, a milk file corresponding to a singular milking animal within the animal group and define a quality and quantity of milk output by the singular animal. In this example, Block S140 can combine the quantity values and average the quality values of milk output by all individual animal within the animal group to generate a milk quality and quantity metric for the animal group for the particular milking event. Block S140 can repeat this process for each milking event and aggregate milk quality and quantity metrics for each milking period into a milk production timeline. Finally, Block S140 can pass this milk production timeline to Block S130, and Block S130 can apply feed, environment, gynecological, and/or other timelines described above to extrapolate trends in milk production with respect to one or more variables and thus identify effects of the one or more variables on milk production within the animal group.

However, Block S140 can implement any other suitable method or technique to collect milk data and/or milking files containing any other relevant information. Block S140 can also display milking data within a user interface associated with the dairy farm account, such as within the farmer's dashboard, as shown in FIGS. 4, 5, and 6.

Block S140 can also recite collecting a set of milking records, each milking record in the set of milking records corresponding to a milking event of the milking animal. In particular, similar to Block S110, Block S140 can implement any of the foregoing methods or techniques to assemble data specific to a single milking animal.

### 8. Milk Production Model

Block S130 of the method S100 recites generating a milk production model for the milking animal based on the set of life events and the set of milking records. Block S130 can subsequently recite, in response to entry of a target milk production value for the milking animal, estimating a milk production profit corresponding to achievement of the target milk production value by the milking animal. Similarly, Block S130 can recite, in response to entry of a target feed value, estimating a milk production value for the milking animal based on the feed schedule and the milk production model for the milking animal.

Generally, Block S130 functions to generate and update a milk production model over time and to implement the milk production model to output a target milk production value and/or an anticipated profit for the target milk production value for the animal group based on one or more parameters related to milk production within the animal group, such as a current measured parameter, a forecast parameter, or a production preference or setting entered by a farmer (or associate).

Block S130 can therefore extrapolate trends within the animal group from various milk production-related data or timelines collected and output in Blocks S102, S110, S120, etc. For example, Block S130 can extrapolating the effects of nutrition, gynecological status, and weather on milk production with the animal group based on nutritional history, gynecological history, environmental history, and milk production history data received from any of the foregoing Blocks of the method S100. As in this example, Block S130 can determine that ambient temperatures between 64° and 78° F. yield a highest milk volume with a milking period for the animal group with milk volume decreasing with temperatures outside of this range, and Block S130 can identify minimum thresholds of starch, sugar, soluble fibers, beta glucans, crude protein, rumen digestible protein, rumen indigestible protein, etc. to achieve a threshold milk quality from the animal group. Block S130 can further define a correlation between milk qualities and/or quantity and a variable with a mathematical function, such as a quadratic function for ‘milk quantity v. ambient air temperature’ and a logarithmic function for ‘milk quality v. soluble fiber mass in animal feed.’ Block S130 can also identify a correlation between milk production output within the group and health status and any of disease diagnoses, medications, animal age, weight, housing and environmental exposure, or any other variable within the group over time, such as by identifying changes in group milk production that coincide with changes in any of the foregoing variables over time.

In one example, Block S130 correlates previous feed schedules and animal fertility data with the milk output weight during a corresponding period of time to generate the milk production model that accounts for both feed and gynecological status in estimating milk output for the milking animal. In this example, Block S130 can also insert into the milk production model nutrition information for the feed provided to the milking animal during the period of time to correlate milk quality with animal nutritional load. Block S130 can further extrapolate effects of weather on milk production volume by the milking animal and thus estimate milk production for the milking animal based on a weather forecast, as described below. However, Block S130 can also aggregate life cycle data, fertility data, feed data, offspring data, waste data, farm asset utilization data, and/or milk production data, etc. for a the milking animal and/or an associated group of milking animals into the milk production model for any one or more milking animals.

Block S130 can also identify a lag time between a milk production-related input and a milk output quality or quantity for the group. For example, Block S130 can determine that a change in feed nutrition on one day does not manifest in a change in milk quality until sixteen hours later. In another example, Block S130 can determine that a twenty-four hour heat wave only effects (e.g., reduces) milk production quantity within the group for the twelve hours following the heat wave, but a week-long heat wave effects milk production for the full week following the end of the heat wave.

Block S130 can thus combine various timelines of milk production-related variables into a mathematical model (or function, algorithm) of milk production and then apply current milk-production variable values to the mathematical model to output the current milk production target. Block S130 can implement statistical methods, pattern recognition, or any other suitable technique or method to extrapolate and correlate variable and milk trends from available milk production and related data for the animal group. As described below, Block S130 can also pass the model to Block S150 to support generation of the feed schedule to achieve the target milk production value.

Block S130 can therefore function to generate a milk production model that defines a group of milking animals as a profit center with costs associated with milk production and incomes associated with milk, manure, calf, and salvage revenues. Block S130 can similarly generate a milk production model that defines a single milking animal as a profit center and then group multiple milk production models for various unique milking animals to simulate production, costs, and incomes for a set, group, farm, region, etc. of milking animals.

### 9. Target Milk Production

Block S130 functions to generate a target milk production value within the animal group for a future milking event or milking period, such as a target milk volume for a milking event (e.g., a morning milking period or an evening milking period), a single day, a week, a month, a quarter, a year, or for any other suitable time period.

In one implementation, Block S130 receives a current local milk price, such as by automatically retrieving a current local milk price from an electronic agricultural database or by prompting the farmer to enter the current milk price into the dashboard within the corresponding dairy production account. Block S130 can then insert current milk price into the milk production model—along with current feed prices, master production cost data, etc.—to identify one or more financial milestones in milk production within the animal group (or herd, subset of the herd, etc.). For example, Block S130 can identify a financial “break-even” milk production quantity for the animal group based on a purchase price of the animal, calves birthed by the animal, an time to first calving by the animal, the current market price for milk, manure, and calves, and the cost of feed, labor, land, capital, etc. support the animal and to produce a volume and/or quality of milk. Block S130 can also identify milk production quantity corresponding to a peak revenue, a peak cost per animal, and a peak profit for the group. Block can further generate cost, revenue, and/or profit trend lines for various milk production quantities within the group for a specific milking event or time period.

For example, in response to entry of a target milk production value for the milking animal, Block S130 can estimate a milk production profit corresponding to achievement of the target milk production value by the milking animal. In this example, Block S130 can receive a current local milk price, estimate a revenue from the target milk production value based on the current local milk price, a quantity and a value of animal waste corresponding to implementation of the feed schedule, a cost of the combination of feed materials specified in the feed schedule, a cost to deliver the feed materials to the milking animal, and a cost to deliver the target milk production value to a target location. Block S130 can then aggregate the incomes from the target milk production value, the value of animal waste, the cost of the combination of feed materials, the cost to deliver the feed materials to the milking animal, and the cost to deliver the target milk production value to a target location into a time-specific milk production profit for the milking animal (or group of milking animals).

In the foregoing implementation, Block S130 can apply the current milk price and/or various other milk production costs for the group to a particular future milking event. In an example implementation, as described above, the method S100 can define lag-lead times for milk production variables and milk output for the group, and Block S130 can apply these lag-leads times to estimate a milk output from the group for a specific future time period based on current variables (e.g., current health status, current weather conditions, current gynecological status, current feed schedule, etc.). By extrapolating these current variables, Block S130 can estimate the future milk output for the group, revenues from this output, and costs for this output, and then cooperate with Block S150 to generate a new feed schedule and target milk production quantity for the specific future time period to achieve a target profit for the group and/or to substantially maximize profitability of the group for the specific future time period.

Block S130 can similarly set a target future milk production quantity for the group based on a weather forecast projection and effects of weather on milk production within the animal group, as defined in the milk production model. For example, Block S130 can receive the weather forecast including details of a future heat wave and generate a reduced target milk production for the group during the heat wave based on a weather effect defined in the model. In this example, Block S130 can apply current and future feed costs, milk pricing, etc. to determine that the cost of increasing feed nutrition and volume and moving the animal group to an air-conditioned holding area to maintain current milk output during the heat wave exceeds the revenue loss from reduced milk production during the heat wave and thus generate the reduced milk production quantity accordingly to substantially maximize milk production profits before, during, and after the heat wave. In this example, Block S130 can also interface with Block S150 to preemptively adjust the feed schedule before the heat wave to correspond to the reduced milk production target during the heat wave and to the heat wave. In this example, Block S130 can also interface with Block S150 to preemptively adjust the feed schedule during the heat wave to correspond to an increased milk production target after the heat wave.

Block S130 can also model variables of milk production that affect milk quality within the group, receive prices corresponding to different milk qualities, and generate target milk production quantities for these different milk qualities accordingly. For example, Block S130 can manipulate a current price for crème and a current price for milk in light of production costs for crème and for milk to determine that crème is more profitable than milk for the animal group. In this example, Block S130 can thus set a higher crème production target and a lower milk production target proportionally for the group, and Block S130 can then cooperate with Block S150 to tailor a feed schedule to yield proportionally more crème and less milk in a future milking event for the animal group. In this example, Block S130 can also determine that milk is more profitable than crème for a second animal group and thus set a higher milk production target and a lower crème production target proportionally for the second animal group than for the first animal group. Block S130 can also cooperate with Block S150 to tailor a second feed schedule for the second animal group to achieve the crème-milk target within the second animal group.

Block S130 can further account for health and/or milk production stress within the animal group. For example, Block S130 can generate the milk production target that remains beneath a threshold safety level, such as defining a maximum milk output from the group based on the health status, gynecological status, nutrition load, age, and weight of animals within the group.

Block S130 can thus apply current and/or projected milk production-related variables to the milk production model to automatically generate the target milk production value (e.g., quantity and/or quality).

Alternatively, Block S130 can interface with the farmer (or farm manager, etc.) to select the target milk production value. For example, Block S130 can display a slider within the farmer's dashboard and prompt the farmer to adjust a virtual milk production target by moving the slider. In this example, as the farmer adjust the position of the slider within the dashboard, Block S130 can calculate a feasibility of a new milk production target for the animal group (e.g., based on a production trend, health status, gynecological cycle, etc. within the group), a stress on the group from the production target, a lead time to achieve the target production value, a feed and waste disposal costs to achieve the production target, a cost to handle and store the milk, and/or an income from the milk sold (i.e., based on a current or projected market price for the milk), etc. Block can then implement any of this data to estimate an immediate profit (e.g., income over feeding cost), a long-term cost to the farm (e.g., based on predicted health effects of reaching the target production value, etc.), and/or capital costs and needs, etc. for the selected target milk production value and display any of this data within the farmer's dashboard. In particular, Block S130 can feed a farmer-selected target milk production value into the milk production model and update the dashboard substantially in real-time to display new results in terms of costs, income, capital requirements, capacity utilization of different resources, predicted animal health effects, and/or health costs, etc. (which may be directly or indirectly related to actual milk production) based on the farmer-selected target milk production value. Block S130 can thus display, to the farmer, the status of multiple farming variables and update these variables with predicted outcomes based on the farmer-selected target milk production value to enable the farmer to make an informed selection of the target milk production.

Block S130 can additionally or alternatively display a slider or other input field type for one or more other variables related to milk production, such as for an animal group specifically or for the herd generally. For example, Block S130 can prompt the farmer to select a number of farmhands available and/or a number of automated milking machines to keep online during a milking event or milking period, and Block S130 can set a maximum limit (i.e., upper control) on milk production based on availability of personnel and/or automated milking machines to milk one or more animal groups during the milking event or milking period. In another example, Block S130 can prompt the farmer to select peak stress or a fraction of maximum milk production load for the animal group and adjust the milk production target accordingly. In this example, Block S130 can estimate a peak milk production load for the animal group (wherein the peak milk production load for the animal group is dynamic and changes with various factors, such as weather, life cycle, gynecological status, etc.), suggest 80% of the peak milk production load as a sustainable milk production target, and prompt the farmer to adjust this fraction of peak milk production load to a preferred setting. Block S130 can then calculate the target milk production value accordingly.

However, Block S130 can function in any other way to specify a milk production target.

Block S130 can also set daily or short-term milk production targets for the animal group based on historic production trends and production-related variables, such as defined in the milk production model. For example, Block S130 can specify higher milk production targets for the spring and fall months, which may historically correlate with higher daily milk production, than for the summer and winter months, which may historically correlate with lower daily milk production.

Block S130 can further account for previous milk production within the animal group when generating a new milk production target for the group. For example, Block S130 can set a lower target milk production quantity on a particular day following a milk production quantity on a preceding day that exceeded a corresponding target volume such that fulfillment of short-term production targets can lead to achievement of a longer-term production target without sacrificing the health of the group of animals, straining (i.e., over-utilizing) available labor, stressing capital capacity, etc. Block S130 can also dynamically adjust short-term milk production targets based on various other external factors, such as birth of a calf or failed equipment.

Over time, Block S130 can update the milk production model according to actual milk production outputs for the animal group. For example, Block S130 can implement supervised or semi-supervised machine learning techniques to update the milk production model by inserting new milk production records received in Block S140 into the milk production model and comparing these records to estimated milk production outputs for the group for the correspond milking event or milking period. In this example, Block S130 can also identify particular factors or variables resulting in a discrepancy between actual and anticipated milk production within the group, such as a difference in actual and forecast temperature or incomplete consumption of a scheduled feed quantity before or during the corresponding milking event. However, Block S130 can function in any other way to update and maintain the milk production model over time based on new milk production and related data collected through one or more Blocks of the method S100.

### 10. Manual Inputs

In one variation of the method S100, Block S130 further updates the milk production model according to virtual changes to production inputs. In this variation, Block S130 can display a virtual representation of the milk production model to the user, such as through the user's dashboard, and adjust model outputs, such as feed schedule, milk production target, and projected profits, based on manually-entered changes to one or more virtual milk production parameters. As described above, the milk production model can be assembled through aggregation and analysis of past, current, and forecast data for the particular animal group, herd, farm, a local or remote herd or farm, food availability, weather (e.g., drought, temperature), milk pricing, labor costs, etc. Block S130 can thus display “knobs and levers” pertaining to one or more production parameters, wherein the farmer can adjust knobs or levers to modulate the model output(s). For example, the farmer can control such parameters as nutritional content, timing, and quantity of feed, market pricing and demand, weather, milk retention or holding period, or milk release date. By providing the user a means with which to view the effect of certain production parameters in real time through a virtual model, Block S130 can teach the farmer to identify weaknesses in his milk production and can enable him to identify and implement key production parameters to increase dairy farm profits. However, Block S130 can function in any other way to update the milk production model according to virtual changes to production inputs provided by the user.

### 11. Feed Schedule

Block S150 of the method S100 recites, in response to entry of a target milk production value for the milking animal, generating a feed schedule for the milking animal based on the milk production model and the set of electronic feed data, the feed schedule specifying a combination of feed materials in the set of available feed materials to achieve the target milk production value by the milking animal. Block S150 further recites, in response to entry of a target feed value, generating a feed schedule for the milking animal based on the target feed value in Block S150B, the feed schedule specifying feed timing and a feed material in the set of available feed materials. Generally, Block S150 functions to implement the milk production model and available feeds to support milk output by a particular milking animal and/or within an animal group to achieve the milk production target output in Block S130 based on a parameter selection by a user (e.g., farmer, associate, etc.). In particular, Block S150 can generate a feed schedule for one or a group of feed animals to achieve machinery, labor, partner, infrastructure, storage, and/or material targets in conjunction with a target milk production value while maintaining suitable short- and/or long-term health, fertility, value and performance of the corresponding milking animal(s). Block S150 can therefore cooperate with Block S130 to aggregate animal group data, to identify trends in milk output, and to correlate trends in group milk output with various factors and inputs (e.g., weather, life cycle, nutrition, health), and Block S150 can specify a feed schedule for the feeding group by accounting for current and/or projected conditions relating to milk production (e.g., weather, life cycle, nutrition, health) and the milk production target output in Block S130. In particular, Block S150 can thus implement various data to generate a feed schedule substantially likely to enable achievement of the milk production target within the animal group in light of production trends and current (and/or forecast) conditions.

In one implementation, Block S150 estimates a nutritional demand for each individual animal within the animal group to achieve, within a threshold, the target average milk production quantity for a specified time period (e.g., a single milking event, a day, a week, etc.). Block S150 can account for nutritional demands of the group, nutritional content of feed, current or forecast weather conditions, the season corresponding to the milking event, scheduled feeding times, a target milk quantity, a target milk quality, labor costs, capital costs, current and/or future market prices, etc. (as defined in the milk production model) to determine a suitable type, content, quality, and timing of feed for the feeding group. For example, to achieve a target milk volume in a milking event, Block S150 can generate a feed schedule specifying a target dry matter, fat, sugar, and water consumption in a feeding period prior to (i.e., leading) the milking event. In this example, to achieve a target milk quality, Block S150 can generate the feed schedule also specifying a target rumen indigestible protein, usable protein, crude fat, ADF, NDF, lignin, micro element consumption within the feeding period (e.g., daily).

Block S150 can manipulate past feed data and corresponding milking data to extrapolate relationships between feed content and quantity and quality of milk output for the group. Block S150 can also predict a lag time between changes in feed nutrition and changes in milk quality and/or quantity and incorporate these relationships and timing constraints into the milk production model. Block S150 can thus set a target feed volume and nutritional content for the group based on the milk production model (including the foregoing relationships and the timing constraints) to achieve the target milk production quality and/or quantity.

In one example implementation, Block S150 generates a feed schedule for a milking animal in response to entry of a target milk production value for the milking animal by a farmer (or associated entity). In this example implementation, Block S150 implements the milk production model to estimate a nutritional demand for the milking animal to achieve the target milk production quantity, within a threshold milk quantity, and selects a combination of feed materials from the set of available feed materials to meet the nutritional demand based on the set of electronic feed data. Block S150 can thus generate the feed schedule accordingly.

In another example implementation, Block S150 generates a feed schedule for the milking animal based on a target feed value entered by a farmer (or associate). In this example implementation, Block S150 selects a combination of feed materials from the set of feed materials with a calculated cost less than a maximum feed event cost prescribed by the target feed value (e.g., cost) and correlated with a target milk production quality based on the milk production model for the milking animal. For example, the farmer can set an upper bound (i.e., limit) on total cost of feed for the animal in a period of time (e.g., a day or a week), and Block S150 can generate the feed schedule that maximizes income from milk production based on current (or forecast) milk prices for milk of certain qualities in light of the upper bound on feed cost set by the farmer.

In yet another example implementation, Block S150 generates a feed schedule for the milking animal based on a farm capital utilization value entered by a farmer (or associate). In this example implementation, Block S150 can estimate a milk production value corresponding to the farm capital utilization value based on the milk production model and then generate a feed schedule for the milking animal based on the milk production model and the set of electronic feed data such that the feed schedule specifies a combination of feed materials likely to achieve the milk production value by the milking animal. For example, the farm capital utilization can include any of a percentage of total machinery capacity used at any one time to manage (e.g., feed, milk, etc.) the milking animal, a total size, cost, or specialization of a labor pool to manage the milking animal, land area or facilities (e.g., a heated barn) needed to house or manage the milking animal, etc., any of which can be entered, selected, or adjusted by the farmer, thus triggering adjustment of a current feed schedule or generation of a new feed schedule in Block S150.

Once the target feed volume and nutritional content is set for the group, Block S150 can select a particular feed material or a combination of feed materials—from the list of available feed materials of known nutritional content—to achieve the target feed volume and nutritional content. For example, Block S150 can select a volume or mass of each of a subset of the available feed materials to approximate each of the dry matter, energy, ash, starch, sugar, soluble fiber, beta glucan, crude protein, rumen digestible protein, rumen indigestible protein, usable protein, crude fat, ADF, NDF, lignin, and/or micro element content targets for the feed. Block S150 can also select quantities (e.g., volumes, masses, weights) of various supplements to add to the feed, such as vitamin, mineral, and antibiotic supplements for the feed.

Block S150 can further select a feed timing, such as based on estimated lag-lead times between changes in feed nutrition and changes in milk output for the group. For example, Block S150 can specify a number of feedings and times for each feeding within the animal group.

As shown in FIG. 3, Block S150 can further combine the selected feed material(s), content, quality, and timing into a daily feed order (DFO) for the animal group. The DFO output in Block S150 can represent a customized feed menu targeted to a particular animal group. The DFO can specify a feed schedule (i.e., feed timing, frequency), a selection from available feeds (and supplements, etc.), and/or a BOM corresponding to a future timed feeding and specifying a blend of available feed components.

In applications in which feed is sourced from a feed storage facility on the dairy farm, Block S150 can transmit the DFO to an onsite feed manager who distributes feed to the feeding group according to the DFO. Block S150 can further settle stored feed quantities according to the DFO in order to maintain current feed inventory data. For example, Block S150 can include transmitting the daily feed order to an onsite feed manager and automatically reconciling a food storage record based on the feed materials and volumes specified in the feed schedule and the feed timing.

Alternatively, in applications in which feed is sourced from an offsite feed service, Block S120 can collect nutritional data of available feeds or feed blends from the feed service, such as from a website of the feed service as described above, and Block S150 can generate the DFO that specifies a feed or feed blend that most closely matches determined nutritional needs of the feeding group. For example, Block S150 can include submitting a feed order to a feed supplier of a feed material—in the set of available feed materials—based on the feed schedule and a food storage record maintained by the feed supplier. Block S150 can similarly specify a BOM and instructions to create a custom feed blend based on feed components available through the feed service. Block S150 can transmit the DFO to the offsite feed service, such as in an email communicated over the Internet. However, Block S150 can function in any other way to generate and communicate a feed schedule to any other suitable feed-related entity.

As Block S140 collects new milk output data for the animal group, such as after application of the feed schedule to the animal group, Block S150 can implement machine learning techniques to adjust or improve the milk production model by feeding these milk output data and the feed schedule back into the milk production model. Block S150 can thus update the feed schedule for the animal group accordingly to better meet the (static or dynamic) target milk production value once the updated feed schedule is implemented within the animal group.

In one example, Block S130 and Block S150 cooperate to update the milk production model with recent or real-time milk production data from one or more milk animals in the group, feed crop production (e.g., harvest) data, cost and income data, milk demand, etc. These Blocks of the method S100 can also augment the milk production model with new forecasts as they become available, such as demand, pricing, and local weather forecasts, as well as milk production data of other animal groups within the herd or on other (local) dairy farms. By systematically comparing milk production model outputs with actual production results, Blocks S130 and S150 can yield an increasingly accurate milk production model customized for a particular animal group, animal herd, or dairy farm, etc.

### 12. Crop Directive

In one application in which animal feed is grown on or in conjunction with the dairy farm, one variation of the method S100 includes Block S160, which recites generating a feed crop directive based on a projected future target milk production, a projected future feed schedule, and a feed crop storage status. Generally, Block S160 functions to generate a recommendation for the user to improve feed crop yield and/or to match feed crop production to nutritional needs of the animal group to achieve a projected or selected milk output. Some dairy farms grow feed crops onsite, and feed crop production can account for a significant portion of milk production costs. Block S160 can therefore link milk production to feed crop production and guide a dairy farm as early in the dairy production process as field preparation and crop planning to support target milk production (and profit projections).

In one implementation, Block S160 collects various crop-related data, such as current and projected crop growth cycle, weather forecast, temperature, season, target production volumes, labor costs, pest infestation, soil quality, soil hydration, soil nutrient content, fertilizer cost, fungicide cost, pesticide cost, herbicide cost, machinery cost, storage availability and allocation, etc., any of which can be automatically-generated and/or manually-entered. Block S160 can thus generate a model of feed crop quantity and/or quality relative to any of the foregoing variables. Based on estimated nutritional demands of the animal group to achieve the target milk production value (output in Block S150) and the feed crop model, Block S160 can thus generate feed crop-related recommendations for the farmer. For example, Block S160 can recommend types of crops, locations of crops, crop watering, application of fertilizers, herbicides, pesticides, or a harvest schedule to achieve a feed crop(s) of a target nutritional content to approximately meet the estimated nutritional needs of the animal group. Block S160 can further update feed store records according to a recent harvest or generate any other suitable recommendation to increase feed crop production and/or to match feed crop production to milk production targets. For example, after a harvest, Block S160 can generate recommendation for a feed material storage location before transfer from the field.

Block S160 can also supply to the farmer (or farmhand, etc.) recommendations pertaining to herd management, such as feed schedule changes, herd relocation, and activation of heated water bins. Block S160 can also directly implement any of the recommendations, such as by controlling a water bin heater directly or by activating a field-watering wiper over a crop or grazing field. However, Block S160 can function in any other way to generate any other suitable type of feed crop directive based on any other relevant crop or milk production data.

### 13. Total Production

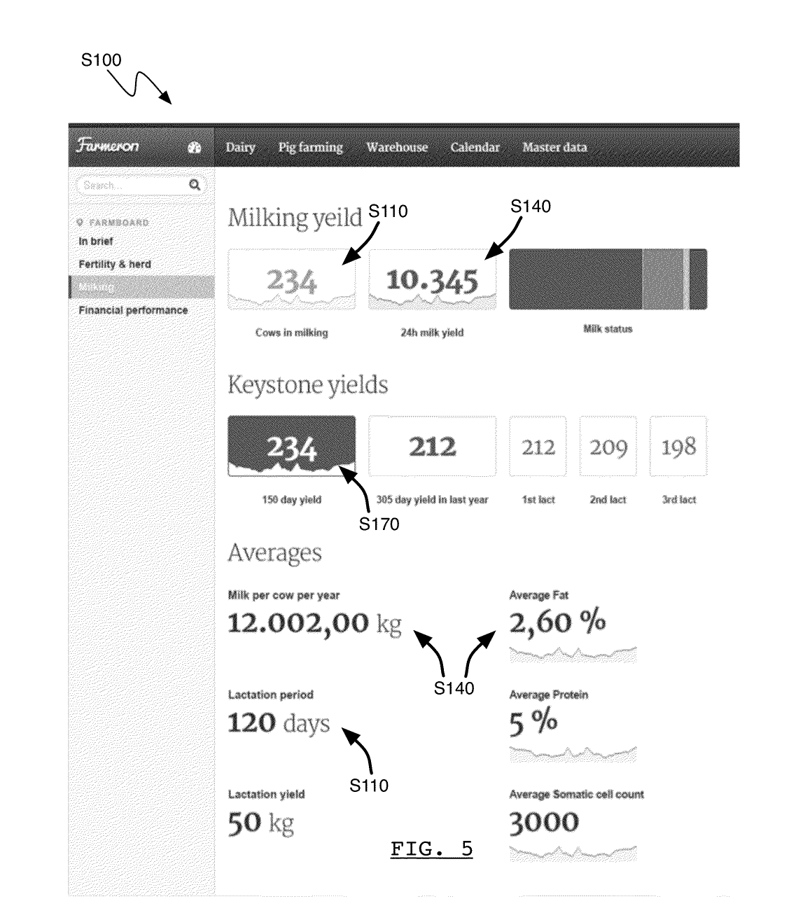

As shown in FIG. 5, one variation of the method S100 includes Block S170, which recites aggregating the target milk production value for the animal group with target milk production values for other groups of milking animals within an animal herd into a total projected milk production value for the animal herd. Generally, Block S170 functions to sum estimated milk production quantities and/or qualities across multiple animal groups to support a higher-level view of estimated milk production on a dairy farm. For example, Block S170 can sum milk production estimates across all animal groups on a dairy farm for all milking periods on a particular future day to estimate total milk volume production for that day. Block S170 can also summarize actual milk quality and/or quantity output into a milk production report for the dairy farm, such as by summing actual milk quality output from all animal groups on the dairy farm. Block S170 can also generate a mixing (or blending) recipe for combining milks from multiple animal groups on the dairy farm to achieve a target milk quality, such as based on prices for milks of different qualities.

Block S170 can also aggregate a total projected milk production value for a particular animal herd or dairy farm with total projected milk production values for one or more other animal herd or dairy farms. For example, Block S170 can sum estimated dairy quality and quantity values for all dairy farms within a locale or region to generate a total regional projected milk production value. The total regional projected milk production value can then be made available to an economist or agricultural agency to set milk prices and/or to predict future milk supply. Alternatively, a user can access the total regional projected milk production value to determine when to release milk to achieve a greatest return. Block S170 can also estimate a market release time for the dairy farm's milk output to substantially maximize income, such as based on historic trends in milk price changes over time and spoilage rates for milk.

However, Block S170 can function in any other way to aggregate target milk production values across multiple animal groups, herds, farms, etc.

Blocks of the method S100 can implement any of the foregoing methods and techniques to manage or output data related to a single milking animal, a set or group of milking animals, a herd of milking animals, a dairy farm, a dairy enterprise (company), a dairy association, a dairy cooperation, etc. The method S100 can also be applied to other types or forms of animal husbandry, such as pig farming, poultry farming, or poultry egg production, etc.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for managing dairy production, comprising:
retrieving a set of electronic feed data comprising nutrition data for feed materials in a set of available feed materials;
receiving a set of life events of a milking animal, the set of life events comprising a gynecological status of the milking animal;
collecting a set of milking records, each milking record in the set of milking records corresponding to a milking event of the milking animal;
generating a milk production model for the milking animal based on the set of life events and the set of milking records;
in response to entry of a target milk production value for the milking animal,
generating a feed schedule for the milking animal based on the milk production model and the set of electronic feed data, the feed schedule specifying a combination of feed materials in the set of available feed materials to achieve the target milk production value by the milking animal, and
estimating a milk production profit corresponding to achievement of the target milk production value by the milking animal; and
in response to entry of a target feed value,
generating a feed schedule for the milking animal based on the target feed value, the feed schedule specifying feed timing and a feed material in the set of available feed materials, and
estimating a milk production value for the milking animal based on the feed schedule and the milk production model for the milking animal.

2. The method of claim 1, wherein retrieving the set of electronic feed data comprises accessing dry matter, sugar, soluble fiber, rumen digestible protein, and crude fat content data of feed materials in the set of available feed materials.

3. The method of claim 1, wherein collecting the set of milking records comprises calculating a milk output weight by the milking animal during a period of time, wherein receiving the set of life events comprises retrieving a previous feed schedule for the milking animal and a fertility status of the milking animal during the period of time, and wherein generating the milk production model for the milking animal comprises correlating the previous feed schedule and the fertility status of the milking animal with the milk output weight during the period of time.

4. The method of claim 3, wherein collecting the set of milking records further comprises calculating a milk output quality by the milking animal during the period of time, and wherein generating the milk production model for the milking animal comprises correlating the previous feed schedule with the milk output quality during the period of time based on nutrition data for a feed material specified in the previous feed schedule.

5. The method of claim 1, wherein collecting the set of milking records comprises collecting the set of milking records from a remote database in communication with an automated milking system, the set of milking records comprises specifying a unique animal identifier and a milk quantity, milk fat content, and milk protein content for a previous milking event of the milking animal.

6. The method of claim 1, wherein receiving the set of life events of the milking animal comprises receiving a nutritional history, a gynecological history, and an environmental history of individual animal within the group of milking animals, wherein generating the milk production model comprises extrapolating effects of nutrition, gynecological status, and weather on milk production volume by the milking animal, and wherein estimating the milk production value for the milking animal comprises estimating the milk production value for the milking animal during a future period of time based on a weather forecast corresponding to the future period of time.

7. The method of claim 1, wherein generating the feed schedule for the milking animal in response to entry of the target milk production value comprises, in response to entry of a target milk production quantity, estimating a nutritional demand for the milking animal to achieve the target milk production quantity, within a threshold milk quantity, and selecting a combination of feed materials from the set of available feed materials to meet the nutritional demand based on the set of electronic feed data.

8. The method of claim 1, wherein estimating the milk production profit in response to entry of the target milk production value comprises receiving a current local milk price, estimating an income from the target milk production value based on the current local milk price, a quantity and a value of animal waste corresponding to implementation of the feed schedule, a cost of the combination of feed materials specified in the feed schedule, a cost to deliver the feed materials to the milking animal, and a cost to deliver the target milk production value to a target location and aggregating the income from the target milk production value, the value of animal waste, the cost of the combination of feed materials, the cost to deliver the feed materials to the milking animal, and the cost to deliver the target milk production value to a target location into a time-specific milk production profit for the milking animal.

9. The method of claim 8, wherein receiving the current local milk price comprises retrieving the current local milk price from an electronic agricultural database, and wherein retrieving the set of electronic feed data comprises mining nutrition data and cost data from an electronic database corresponding to a supplier of a feed material in the set of available feed materials.

10. The method of claim 1, wherein generating the feed schedule for the milking animal in response to entry of the target feed value comprises selecting a combination of feed materials from the set of feed materials with a calculated cost less than a maximum feed event cost prescribed by the target feed value and correlated with a target milk production quality based on the milk production model for the milking animal.

11. The method of claim 11, wherein estimating the milk production value for the milking animal in response to entry of the target feed value comprises estimating a milk production quantity by the milking animal at the target milk quality based on the milk production model.

12. The method of claim 1, wherein generating the feed schedule comprises generating a daily feed order corresponding to a future timed feeding event and comprising a bill of materials for available feed materials.

13. The method of claim 12, wherein generating the feed schedule comprises transmitting the daily feed order to a feed manager associated with a farm housing the milking animal and reconciling a feed material storage record based on the bill of materials.

14. The method of claim 1, further comprising, in response to entry of a farm capital utilization value,
estimating a milk production value corresponding to the farm capital utilization value based on the milk production model, and
generating a feed schedule for the milking animal based on the milk production model and the set of electronic feed data, the feed schedule specifying a combination of feed materials in the set of available feed materials to achieve the milk production value by the milking animal.

15. The method of claim 14, wherein generating the milk production model comprises aggregating life cycle data, fertility data, feed data, offspring data, waste data, farm capital utilization data, and milk production data for a group of milking animals into the milk production model, the group of milking animals comprising the milking animal.

16. The method of claim 1, further comprising identifying a similarity between the milk production model for the milking animal and milk production characteristics of a group of milking animals and prompting placement of the milking animal into group of milking animals.

17. A method for managing dairy production, comprising:
retrieving a set of electronic feed data comprising nutrition data for feed materials in a set of available feed materials;
receiving a set of life events of a first group of milking animals, the set of life events comprising a gynecological status of a milking animal within the first group of milking animals;
collecting a set of milking records, each milking record in the set of milking records corresponding to a milking event of milking animal within the first group of milking animals;
in response to entry of a target milk production value for the first group of milking animals, generating a feed schedule for the first group of milking animals based on the set of life events, the set of milking records, and the set of electronic feed data, the feed schedule specifying a feed timing and a combination of feed materials in the set of available feed materials to achieve the target milk production value by milking animals in the first group of milking animals;
in response to detecting deviation from the target milk production value by a particular milking animal in the first group of milking animals, selecting a second group of milking animals with characteristics compatible with the particular milking animal based on the deviation from the target milk production value and the feed schedule; and
prompting placement of the particular milking animal into the second group of milking animals.

18. A method of claim 17, wherein selecting the second group of milking animals comprises identifying milk production volume output by the particular milking animal that falls short of a target milk production quantity by a quantity threshold over a set of milking periods and selecting the second group that comprises milk animals culled from a herd of milk production animals, and wherein prompting placement of the particular milking animal into the second group of milking animals comprises prompting culling of the particular milking animal from the herd.

19. The method of claim 18, wherein prompting placement of the particular milking animal into the second group of milking animals comprises generating a notification to cull the particular milking animal based on a unique animal identifier associated with the particular milking animal.

20. A method for managing dairy production, comprising:
receiving a set of life events of a group of milking animals, the set of life events comprising a gynecological status;
retrieving a set of electronic feed data comprising nutritional data for feed materials in a set of available feed materials;
collecting a set of milking records from an automated milking system, each milking record in the set of milking records corresponding to a milking event for an individual animal within the group of milking animals;
setting a target milk production value for the group of milking animals; and
generating a feed schedule for the group of milking animals based on the set of life events, set of electronic feed data, and the set of milking records, the feed schedule specifying feed timing and a combination of feed materials in the set of available feed materials to achieve the target milk production value within the group of milking animals.
